(19) United States
(12) Patent Application Publication
(10) Pub. No.: US 2021/0089672 A1
(43) Pub. Date: Mar. 25, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Fumihisa SUZUKI, Kanagawa (JP)

(73) Assignee: FUJI XEROX CO., LTD., Tokyo (JP)

(21) Appl. No.: 16/745,380

(22) Filed: Jan. 17, 2020

(30) Foreign Application Priority Data
Sep. 19, 2019 (JP) 2019-170314

(51) Int. Cl. G06F 21/62

(52) U.S. Cl. CPC G06F 21/6218

(57) ABSTRACT

An information processing apparatus includes a processor configured to: receive a request made by a first user who has a usage right to use a function of an apparatus to be used; output delegation information representing that the usage right to use the function is to be delegated to a second user who does not have the usage right to use the function, the delegation information including state information that represents a state of shared resources that are used when the function is used and that represents a state upon receipt of the request; receive the delegation information; and permit or restrict use of the function in accordance with a result of comparison between the state of the shared resources upon receipt of the delegation information and the state represented by the state information included in the received delegation information.

### CROSS-REFERENCE TO RELATED APPLICATIONS

This application is based on and claims priority under 35 USC 119 from Japanese Patent Application No. 2019-170314 filed Sep. 19, 2019.

### BACKGROUND

### (i) Technical Field

The present disclosure relates to an information processing apparatus and a non-transitory computer readable medium.

### (ii) Related Art

A usage right to use a function of an apparatus may sometimes be given to a user who does not have this usage right.

Japanese Unexamined Patent Application Publication No. 2007-249912 describes a system for giving, in response to a request made by a user who is usually allowed to use shared resources, the right to use the shared resources for a certain period of time to a substitute user who is usually not allowed to use the shared resources.

By the way, in the case where a usage right to use a function of an apparatus is given to a user who does not have this usage right, the state of the apparatus may sometimes change from when the usage right is given to the user to when the user uses the apparatus. In this case, a situation may occur in which the apparatus is used by the user who has been given the usage right in a state unexpected by a user who has given the usage right.

### SUMMARY

Aspects of non-limiting embodiments of the present disclosure relate to preventing the use of an apparatus in a state unexpected by a user who has given a usage right to use a function of the apparatus to another user who does not have the usage right, by this other user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive a request made by a first user who has a usage right to use a function of an apparatus to be used; output delegation information representing that the usage right to use the function is to be delegated to a second user who does not have the usage right to use the function, the delegation information including state information that represents a state of shared resources that are used when the function is used and that represents a state upon receipt of the request; receive the delegation information; and permit or restrict use of the function in accordance with a result of comparison between the state of the shared resources upon receipt of the delegation information and the state represented by the state information included in the received delegation information.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to an exemplary embodiment;

FIG. 2 is a block diagram illustrating the hardware configuration of a right management apparatus according to the present exemplary embodiment;

FIG. 3 is a block diagram illustrating the functional configuration of the right management apparatus according to the present exemplary embodiment;

FIG. 4 is a flowchart illustrating a process of giving a usage right;

FIG. 5 is a flowchart illustrating a process of using an apparatus using a usage right; and

FIG. 6 is a diagram illustrating a screen.

### DETAILED DESCRIPTION

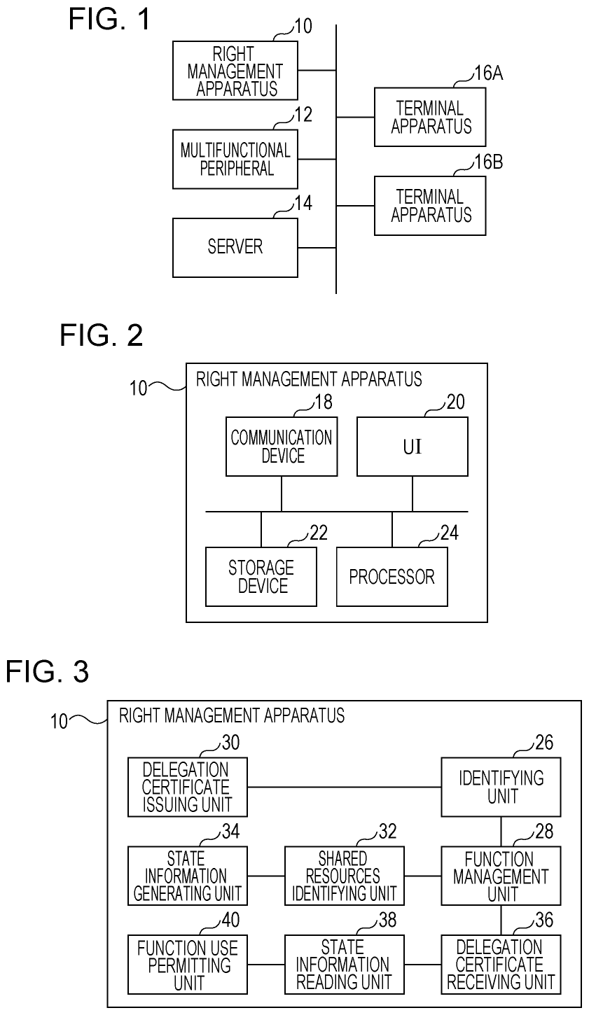

An information processing system according to an exemplary embodiment will be described with reference to FIG. 1. FIG. 1 illustrates an example of the configuration of the information processing system according to the present exemplary embodiment.

The information processing system according to the present exemplary embodiment includes, for example, a right management apparatus 10, which is an example of an information processing apparatus, a multifunctional peripheral 12, which is an example of an image processing apparatus, a server 14, and terminal apparatuses 16A and 16B. The information processing system may include apparatuses other than these apparatuses. The number of apparatuses included in the information processing system is only one example, and the number of each of the apparatuses is not restricted to the number of each of the apparatuses illustrated in FIG. 1. Note that the information processing system need not include the server 14 or the terminal apparatuses 16A and 16B.

The right management apparatus 10, the multifunctional peripheral 12, the server 14, and the terminal apparatuses 16A and 16B have the function to communicate with other apparatuses. The communication may be wired communication using cables or may be wireless communication. In short, each apparatus may be physically connected to other apparatuses by cables and transmit/receive information to/from each other, or may transmit/receive information to/from each other by wireless communication. As wireless communication, near-field communication (NFC) or Wi-Fi (registered trademark) is used, for example. Alternatively, wireless communication conforming to other standards may be used. NFC includes, for example, Bluetooth (registered trademark) and radio frequency identifier (RFID). Each apparatus may communicate with other apparatuses via a communication channel such as a local area network (LAN) or the Internet.

The right management apparatus 10 is an apparatus configured to manage a function usable by a user on an apparatus managed by the right management apparatus 10. For example, the right management apparatus 10 temporarily gives a usage right to use a function of an apparatus to a user who does not have the usage right to use the function. For example, the multifunctional peripheral 12 is managed by the right management apparatus 10. Needless to say, apparatuses other than the multifunctional peripheral 12 may be managed by the right management apparatus 10.

The multifunctional peripheral 12 is an example of an apparatus managed by the right management apparatus 10, and is an image processing apparatus that has at least one of a scan function, a print function, a copy function, and a fax function.

The right management apparatus 10 may be included in the multifunctional peripheral 12. In short, the right management apparatus 10 may be built in the multifunctional peripheral 12, and the multifunctional peripheral 12 may have the function(s) of the right management apparatus 10. In this case, the multifunctional peripheral 12 manages a function usable on the multifunctional peripheral 12, which is a local apparatus, by a user who uses the multifunctional peripheral 12. In addition, the multifunctional peripheral 12 temporarily give a usage right to use a function usable on the multifunctional peripheral 12 to a user who does not have the usage right to use the function. Note that the multifunctional peripheral 12 in which the right management apparatus 10 is built corresponds to an example of an information processing apparatus.

The server 14 is an apparatus where various types of data are stored. For example, image data is transmitted from the multifunctional peripheral 12 to the server 14, and the image data is stored in the server 14. In addition, image data may be transmitted from the server 14 to the multifunctional peripheral 12, and the image data may be printed by the multifunctional peripheral 12.

The terminal apparatuses 16A and 16B are personal computers (hereinafter abbreviated as “PCs”), tablet PCs, smartphones, cellular phones, or the like.

Hereinafter, the hardware configuration of the right management apparatus 10 will be described with reference to FIG. 2. FIG. 2 illustrates an example of the hardware configuration of the right management apparatus 10.

The right management apparatus 10 includes, for example, a communication device 18, a user interface (UI) 20, a storage device 22, and a processor 24.

The communication device 18 is a communication interface, and has the function to transmit information to another device and the function to receive information transmitted from another device. The communication device 18 may have a wireless communication function or a wired communication function. The communication device 18 may communicate with another device by using, for example, NFC, or may communicate with another device via a communication channel such as a LAN or the Internet.

The UI 20 is a user interface, and includes a display device and an operation device. The display device is, for example, a liquid crystal display or an electroluminescence (EL) display. The operation device includes, for example, a keyboard, input keys, and an operation panel. The UI 20 may be a UI such as a touchscreen that serves as both a display device and an operation device. In addition, a microphone may be included in the UI 20, or a loudspeaker that emits sound may be included in the UI 20.

The storage device 22 is a device that configurates one or more storage areas for storing various types of information. The storage device 22 is, for example, a hard disk drive, various types of memory (such as random-access memory (RAM), dynamic RAM (DRAM), and read-only memory (ROM)), other storage devices (such as optical discs), or a combination thereof. One or more storage devices 22 are included in the right management apparatus 10.

The processor 24 is configured to control the operation of each unit of the right management apparatus 10. For example, the processor 24 may communicate with each device using the communication device 18, display information on the display device of the UI 20, receive information entered via the UI 20, store information in the storage device 22, or read information from the storage device 22. The processor 24 may include memory.

Note that the multifunctional peripheral 12, the server 14, and the terminal apparatuses 16 each include a communication device, a UI, a storage device, and a processor.

Hereinafter, an example of the functional configuration of the right management apparatus 10 will be described with reference to FIG. 3. FIG. 3 illustrates an example of the functional configuration of the right management apparatus 10. The function of each configuration discussed below is implemented by the processor 24.

An identifying unit 26 is configured to identify a user who uses an apparatus. For example, the identifying unit 26 receives user identification information for identifying a user, and identifies a user who uses an apparatus on the basis of the user identification information. An apparatus to be used may be the multifunctional peripheral 12 or another apparatus. User identification information is, for example, a user's name, user identification (ID), or user account. The identifying unit 26 may receive user identification information entered by a user by operating the UI 20, or may read user identification information from an integrated circuit (IC) card where user identification information is stored.

In the case where the right management apparatus 10 is built in the multifunctional peripheral 12, the identifying unit 26 receives user identification information input to the multifunctional peripheral 12, which is a local apparatus, and identifies a user who uses the multifunctional peripheral 12. For example, user identification information is input to the multifunctional peripheral 12 when a user logs in to the multifunctional peripheral 12, and the identifying unit 26 identifies the user who logs in to the multifunctional peripheral 12. The identifying unit 26 may authenticate a user on the basis of user identification information. For example, the identifying unit 26 may permit or prohibit a user represented by the received user identification information to log in or from logging in to the multifunctional peripheral 12 by determining whether the user has the right to log in to the multifunctional peripheral 12.

A function management unit 28 is configured to manage a function usable on an apparatus to be used by a user identified by the identifying unit 26. A user who is allowed to use a function is a user who has a usage right to use the function. For example, for every user, the user's user identification information and function information representing a function for which the user has a usage right are associated with each other in advance, and right management information that represents the association is stored in the storage device 22 or another device. The function management unit 28 identifies, using right management information, a function associated with user identification information of a user identified by the identifying unit 26, thereby identifying a function for which the user has a usage right. In the case where a user identified by the identifying unit 26 has a usage right to use a certain function, the function management unit 28 permits the user to use the function. In the case where a user identified by the identifying unit 26 does not have a usage right to use a certain function, the function management unit 28 restricts the user to use the function. Restricting the use of a function refers to not permitting the use of the entire function (in short, prohibiting the use of the entire function), or permitting the use of part of the function and not permitting the use of the remaining function.

In the case where the right management apparatus 10 is built in the multifunctional peripheral 12, the function management unit 28 manages a function usable by a user identified by the identifying unit 26 on the multifunctional peripheral 12, which is a local apparatus. For example, the function management unit 28 determines whether a user who logs in to the multifunctional peripheral 12 has a usage right to use a function usable on the multifunctional peripheral 12, and permits or restricts the user to use the function.

A delegation certificate issuing unit 30 is configured to receive a request made by a user who has a usage right to use a function of an apparatus to be used, and, in accordance with the request, generate and output delegation information representing that the usage right to use the function is to be delegated to a user who does not have the usage right to use the function. As will be described later, the delegation certificate issuing unit 30 outputs delegation information including state information generated by a state information generating unit 34.

Hereinafter, a user who has a usage right to use a function will be referred to as a “first user”, and a user who does not have the usage right to use the function and who is given the usage right to use the function will be referred to as a “second user”. In addition, hereinafter, giving a usage right to use a function to the second user will sometimes be referred to as delegating the usage right to use the function to the second user.

Delegation information is information representing that a usage right to use a function represented by the delegation information is to be temporarily delegated to the second user. In short, delegation information is information that proves that a function represented by the delegation information is temporarily permitted to be used by the second user. As described here, the usage right given to the second user is the right that temporarily permits the use of the function. As will be described later, using delegation information, the second user is temporarily permitted to use a function represented by the delegation information.

Delegation information includes, for example, function information representing a function permitted to be used, restriction information representing a period or the number of times the use of the function is permitted, and information that proves that the use of the function is temporarily permitted. For example, the second user is permitted to use a function represented by the function information within a period represented by the restriction information, or is permitted to use a function represented by the function information for the number of times represented by the restriction information. Delegation information may include user identification information for identifying the first user, and user identification information for identifying the second user.

For example, in the case where the right management apparatus 10 is built in the multifunctional peripheral 12, function information included in delegation information is information that represents a function permitted to be used by the second user on the multifunctional peripheral 12.

Outputting delegation information may be performed by displaying the delegation information on the display device of the UI 20, transmitting the delegation information to another apparatus (such as the second user's terminal apparatus 16) through communication, transmitting the delegation information to the second user's address, printing the delegation information, or a combination thereof. The address of another apparatus and the second user's address are specified by the first user when the first user makes a request to delegate the usage right.

The delegation certificate issuing unit 30 may code delegation information and output the coded delegation information. For example, the delegation certificate issuing unit 30 may generate and output a bar code or a two-dimensional code (such as a Quick Response (QR) code (registered trademark)) representing delegation information. In this case, a bar code or a two-dimensional code representing delegation information is displayed on the display device of the UI 20, transmitted to the second user's terminal apparatus 16, or printed.

For example, when the first user identified by the identifying unit 26 operates the UI 20 to give a command to execute a right delegation process for giving a usage right to the second user, the delegation certificate issuing unit 30 displays a list of functions for which the first user has usage rights on the display device of the UI 20. When the first user specifies an apparatus to be used, a list of functions for which the first user has usage rights, among a group of functions usable on the specified apparatus, is displayed on the display device of the UI 20. When the first user operates the UI 20 to select from the list a function whose usage right is to be given to the second user and gives a command to delegate the usage right, the delegation certificate issuing unit 30 generates and outputs delegation information representing that the usage right to use the function selected by the first user is to be delegated to the second user. Note that the first user may operate the UI 20 to enter the user identification information of the second user. In this case, the user identification information of the second user may be included in delegation information.

In the case where the right management apparatus 10 is built in the multifunctional peripheral 12, when the first user who has logged in to the multifunctional peripheral 12 gives a command to execute a right delegation process, the delegation certificate issuing unit 30 displays a list of functions for which the first user has usage rights, among a group of functions usable on the multifunctional peripheral 12, which is a local apparatus, on the display device of the UI 20. The first user selects from the list a function whose usage right is to be given to the second user.

A shared resources identifying unit 32 is configured to identify shared resources shared when a function is used. For example, when the first user specifies a function whose usage right is to be given to the second user, the shared resources identifying unit 32 identifies shared resources that are used when using this function. For example, for every function, function information for representing the function, and shared resources information representing shared resources that are used when using the function are associated with each other in advance, and shared resources management information representing the association is stored in the storage device 22 or another device. When a function whose usage right is to be given to the second user is specified, the shared resources identifying unit 32 identifies shared resources associated with the specified function in the shared resources management information, thereby identifying shared resources that are used when using the specified function.

Alternatively, the first user may specify shared resources that are used when using a function. For example, it is conceivable that the first user specifies a function whose usage right is to be given to the second user, as well as shared resources that are used when using this function. When shared resources are specified by the first user, the shared resources identifying unit 32 identifies the shared resources specified by the first user as shared resources that are used when using the function.

Shared resources include, for example, the physical configuration of an apparatus to be used by a user, the logical configuration of the apparatus, information stored in the apparatus, the physical configuration of another apparatus other than the apparatus in interest, the logical configuration of this other apparatus, and information stored in this other apparatus.

Shared resources related to the multifunctional peripheral 12 will be described by way of example. Data of an address book for managing phone numbers and addresses (such as email addresses and Internet Protocol (IP) addresses), a paper tray of the multifunctional peripheral 12 for containing paper sheets to be printed, and a storage area where data generated by the multifunctional peripheral 12 is stored (for example, a storage area called a confidential box or the like) correspond to examples of shared resources. Data of an address book may be stored in the multifunctional peripheral 12 or in an apparatus other than the multifunctional peripheral 12 (such as the server 14). A storage area serving as shared resources may be a storage area formed in the multifunctional peripheral 12, or may be a storage area formed in an apparatus other than the multifunctional peripheral 12 (such as the server 14). In short, shared resources related to the multifunctional peripheral 12 may be shared resources that the multifunctional peripheral 12 has or may be shared resources that an apparatus other than the multifunctional peripheral 12 has, as long as they are shared resources that are used when using a function on the multifunctional peripheral 12.

A user who has a usage right to use shared resources is permitted to use the shared resources. A user who has a usage right to use shared resources may be a user who has a usage right to use a function that uses the shared resources, or may be a user who has a usage right to use the shared resources, which is separately defined from the usage right to use the function.

In addition, shared resources are managed by the administrator of the shared resources. The administrator may be a user who has a usage right to use a function that uses the shared resources, or may be another user other than the foregoing user, who has a usage right to use the shared resources. The state of shared resources is changeable by the administrator. For example, the state of shared resources is changeable by another user other than the first user who gives a usage right to use a function that uses the shared resources to the second user.

The state information generating unit 34 is configured to generate state information representing the state of shared resources identified by the shared resources identifying unit 32, and include the state information in delegation information generated by the delegation certificate issuing unit 30. Including state information in delegation information may be done by embedding the state information in the delegation information, or by attaching the state information to the delegation information.

The delegation certificate issuing unit 30 outputs delegation information including state information. In addition, the delegation certificate issuing unit 30 may code and output delegation information including state information. For example, the delegation certificate issuing unit 30 may generate and output a bar code or a two-dimensional code representing delegation information including state information.

The state information generating unit 34 generates state information representing the state of shared resources at a time point at which the first user makes a request to give a usage right to use a function to the second user. A time point at which the first user makes a request to give a usage right to use a function to the second user may be a time point at which the first user operates the UI 20 to give a command to delegate the usage right, a time point at which the delegation certificate issuing unit 30 receives the command, or during a period in which the first user performs operations related to delegation of the usage right (for example, a period of time from when the first user gives a command to delegate the usage right to when delegation information is generated).

For example, state information is a hash value representing the state of shared resources. The state information generating unit 34 generates a hash value representing the state of shared resources using a cryptographic hash function, such as a unidirectional hash function. The state information generating unit 34 includes the generated hash value in delegation information representing that a usage right to use a function that uses the shared resources is to be delegated to the second user.

The delegation certificate issuing unit 30 outputs delegation information including a hash value generated by the state information generating unit 34. In addition, the delegation certificate issuing unit 30 may generate and output a bar code or a two-dimensional code representing the delegation information including the hash value.

A delegation certificate receiving unit 36 is configured to receive delegation information. Delegation information may be input to the right management apparatus 10 via the UI 20, or may be input to the right management apparatus 10 by being read by a reading device such as a camera or a scanner. For example, in the case where a two-dimensional code representing delegation information is output, when the second user holds the two-dimensional code in front of a reading device, the reading device reads the two-dimensional code, and the delegation certificate receiving unit 36 receives the two-dimensional code.

A state information reading unit 38 is configured to read, from delegation information received by the delegation certificate receiving unit 36, state information included in the delegation information. For example, on receipt of the above-mentioned two-dimensional code by the delegation certificate receiving unit 36, the state information reading unit 38 decodes the two-dimensional code to generate delegation information from the two-dimensional code, and reads state information (such as a hash value) from the delegation information.

On receipt of delegation information by the delegation certificate receiving unit 36, the shared resources identifying unit 32 identifies shared resources that are used when using a function represented by function information included in the received delegation information.

A function use permitting unit 40 is configured to permit or restrict the use of a function represented by function information included in delegation information received by the delegation certificate receiving unit 36, on the basis of the delegation information. A process performed by the function use permitting unit 40 will be described in detail. When delegation information is received by the delegation certificate receiving unit 36 and shared resources are identified by the shared resources identifying unit 32 on the basis of the received delegation information, the function use permitting unit 40 identifies the state of the shared resources upon receipt of the delegation information by the delegation certificate receiving unit 36. Next, the function use permitting unit 40 permits or restricts the use of a function represented by function information included in the delegation information in accordance with the result of comparison between the state of the shared resources upon receipt of the delegation information by the delegation certificate receiving unit 36 and a state represented by state information read from the delegation information by the state information reading unit 38. Hereinafter, for the sake of convenience, the state of the shared resources upon receipt of the delegation information by the delegation certificate receiving unit 36 will be referred to as a “first state”, and a state represented by state information read from the delegation information by the state information reading unit 38 will be referred to as a “second state”.

In the case where the first state and the second state match, the function use permitting unit 40 permits the use of a function represented by function information included in the delegation information. In the case where the first state and the second state do not match, the function use permitting unit 40 restricts the use of the function. The function use permitting unit 40 may not permit the use of the entire function, or may permit the use of part of the function and not permit the use of the remaining part of the function.

In the case where a hash value is used as state information, the function use permitting unit 40 generates a hash value representing the state of the shared resources upon receipt of the delegation information by the delegation certificate receiving unit 36, compares the generated hash value (hereinafter referred to as a “first hash value”) and a hash value (hereinafter referred to as a “second hash value”) read by the state information reading unit 38, and permits or restricts the use of the function in accordance with the result of the comparison. In the case where the first hash value and the second hash value match, the function use permitting unit 40 permits the use of the function. In the case where the first hash value and the second hash value do not match, the function use permitting unit 40 restricts the use of the function.

Hereinafter, the information processing system according to the present exemplary embodiment will be described in more detail. Hereinafter, it is assumed that the right management apparatus 10 is built in the multifunctional peripheral 12, and the multifunctional peripheral 12 has the same function(s) as the right management apparatus 10. It is also assumed that the multifunctional peripheral 12 is an apparatus used by users, and a usage right to use a function used on the multifunctional peripheral 12 is to be given to the second user.

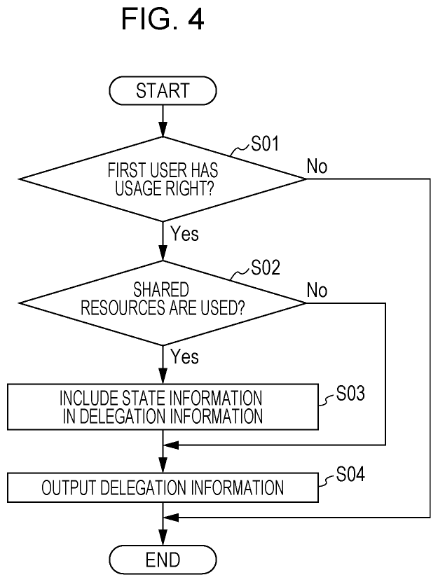

Hereinafter, a process of giving a usage right to the second user will be described with reference to FIG. 4. FIG. 4 illustrates a flowchart representing the process.

At first, when the first user inputs the first user's user identification information to the multifunctional peripheral 12, the identifying unit 26 identifies the first user. When the first user selects a function whose usage right is to be given to the second user and gives a command to delegate the usage right, the function management unit 28 determines whether the first user has the usage right to use the function (S01). In the case where the first user does not have the usage right to use the function (NO in S01), the process ends.

In the case where the first user has the usage right to use the function (YES in S01), the shared resources identifying unit 32 determines whether shared resources are used when using the function (S02). In addition, the delegation certificate issuing unit 30 receives a command to delegate the usage right, and generates delegation information representing that the usage right to use the function is to be delegated to the second user.

In the case where shared resources are used (YES in S02), the state information generating unit 34 generates state information representing the state of the shared resources, and includes the state information in the delegation information. The delegation certificate issuing unit 30 outputs the delegation information including the state information (S04).

In the case where shared resources are not used (NO in S02), no state information is generated, and the delegation certificate issuing unit 30 outputs the delegation information (S04).

The second user receives the output delegation information.

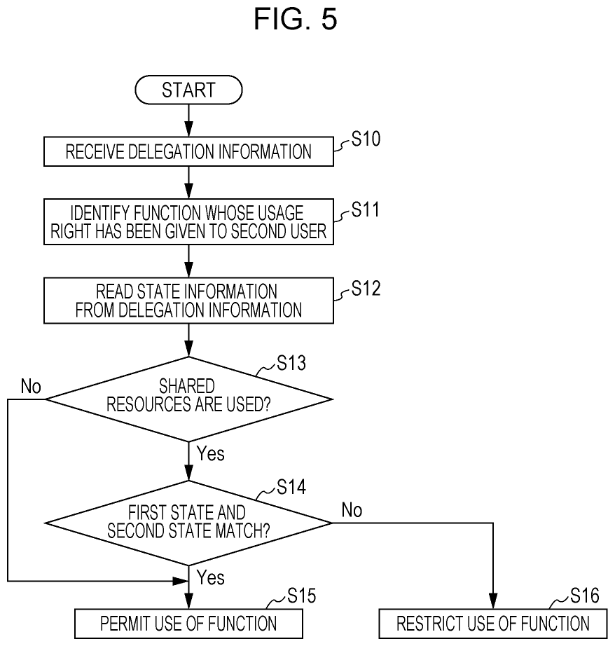

Hereinafter, a process of using the multifunctional peripheral 12 using a usage right will be described with reference to FIG. 5. FIG. 5 illustrates a flowchart representing the process.

When the second user inputs delegation information to the multifunctional peripheral 12, the delegation certificate receiving unit 36 receives the delegation information (S10).

On the basis of the delegation information received by the delegation certificate receiving unit 36, the function use permitting unit 40 identifies a function whose usage right has been given to the second user (S11). A function represented by state information included in the delegation information is a function whose usage right has been given to the second user.

In the case where state information is included in delegation information received by the delegation certificate receiving unit 36, the state information reading unit 38 reads, from the delegation information, the state information included in the delegation information (S12).

In the case where shared resources are used when using a function whose usage right has been given to the second user (YES in S13), the function use permitting unit 40 compares the state of the shared resources upon receipt of the delegation information by the delegation certificate receiving unit 36 (namely, the first state) and a state represented by state information read from the delegation information (namely, the second state) (S14).

In the case where the first state and the second state match (YES in S14), the function use permitting unit 40 permits the use of the function whose usage right has been given to the second user (S15).

In the case where the first state and the second state do not match (NO in S14), the function use permitting unit 40 restricts the use of the function (S16).

In the case where shared resources are not used when using a function whose usage right has been given to the second user (NO in S13), the function use permitting unit 40 permits the use of the function (S15).

For example, the function use permitting unit 40 permits the use of a function that uses shared resources in the case where the first state and the second state match, and does not permit the use of the whole shared resources in the case where the first state and the second state do not match. In the case where the first state and the second state match, the function use permitting unit 40 permits the use of shared resources that are used when using the function.

As another example, the function use permitting unit 40 may permit the use of a function that uses shared resources in the case where the first state and the second state match, and, in the case where the first state and the second state do not match, may permit the use of only a portion of the shared resources that are used when using the function, the portion having a state upon receipt of a command from the first user to delegate the usage right to use the function. For example, the state information generating unit 34 stores, in the storage device 22, state information representing the state of the shared resources upon receipt of a command from the first user to delegate the usage right to use the function. In short, the state information generating unit 34 stores, in the storage device 22, state information included in delegation information. For example, after delegation information for giving a usage right to use a function to the second user has been generated, if the state of shared resources that are used when using the function is changed, the state information generating unit 34 generates state information representing the state of the shared resources before the change and stores the state information in the storage device 22. Whenever the state of the shared resources is changed, the state information generating unit 34 generates state information representing the state of the shared resources before the change and stores the state information in the storage device 22. The function use permitting unit 40 permits the use of a portion of the shared resources that has a state represented by state information included in delegation information input to the multifunctional peripheral 12 by the second user, and does not permit the use of a portion of the shared resources that has a state other than the state represented by the state information. In short, the function use permitting unit 40 permits the use of a portion of the shared resources that has not been changed since the delegation information has been generated, and does not permit the use of a part of the shared resources that has been changed since the delegation information has been generated.

Hereinafter, a specific example will be described. Here, as an example, it is assumed that the first user has a usage right to use a scan transfer function using an address book, and the second user does not have the usage right to use the scan transfer function using the address book.

Data of the address book is an example of shared resources that are used when using the scan transfer function. In the address book, for example, for each destination, the destination's name, phone number, and address (such as an e-mail address or an IP address) are registered in association with one another. Information other than these items of information may be registered in the address book.

The scan transfer function is the function of generating image data that represents a document by scanning the document, and transmitting the image data to a destination. For example, the multifunctional peripheral 12 scans a document, and image data generated from the scan is transmitted from the multifunctional peripheral 12 to a destination selected from the address book. For example, the image data is transmitted to the destination by email or the like. Hereinafter, image data generated by a scan will be referred to as “scanned data”.

The first user has the right to refer to all destinations registered in the address book, and transmit scanned data by email to any of the destinations registered in the address book. In short, the first user is allowed to transmit scanned data by email to a destination arbitrarily selected from the address book.

In this example, it is assumed that the first user delegates the second user a temporal usage right to use the scan transfer function of transmitting scanned data by email using the address book.

At first, when the first user inputs the first user's user identification information to the multifunctional peripheral 12 and makes a log-in request, the identifying unit 26 identifies the first user on the basis of the user identification information, and permits the first user to log in to the multifunctional peripheral 12.

The function management unit 28 identifies a function(s) for which the first user has a usage right(s). In addition, the first user operates the UI 20 to make a request to the multifunctional peripheral 12 to delegate the second user the usage right to use the scan transfer function of transmitting scanned data by email using the address book. On receipt of the request, the function management unit 28 confirms that the first user has the usage right to use the scan transfer function of transmitting scanned data by email using the address book.

In the case where it is confirmed that the first user has a usage right to use the scan transfer function of transmitting scanned data by email using the address book, the delegation certificate issuing unit 30 generates delegation information for giving a temporal usage right to use the scan transfer function of transmitting scanned data by email using the address book to a user who does not have the usage right to use the scan transfer function. The delegation information includes function information representing the scan transfer function of transmitting scanned data by email using the address book.

In addition, the shared resources identifying unit 32 identifies that data of the address book serves as shared resources. The state information generating unit 34 generates a hash value (namely, a second hash value) of every item of data of the address book upon receipt of the request made by the first user, and includes the second hash value in the delegation information. The second hash value of every item of data of the address book is an example of state information representing the state of the address book.

The delegation certificate issuing unit 30 generates and outputs a bar code or a two-dimensional code representing delegation information including the hash value of every item of data of the address book. Here, as an example, the delegation certificate issuing unit 30 generates and outputs a QR code serving as an example of two-dimensional code.

A QR code, which is delegation information, is displayed on the UI 20, printed by the multifunctional peripheral 12, or transmitted to the second user's terminal apparatus 16 (such as the terminal apparatus 16B) using NFC or the like. Accordingly, the QR code is given to the second user.

Note that the first user may use the first user's terminal apparatus 16 (such as the terminal apparatus 16A) to make a request to the multifunctional peripheral 12 to delegate the usage right to use the scan transfer function to the second user. Information representing the request is transmitted from the terminal apparatus 16A to the multifunctional peripheral 12, and is received by the multifunctional peripheral 12. In this manner, a request to delegate the usage right may be made by the multifunctional peripheral 12 or may be made by the terminal apparatus 16 of a user who delegates the usage right.

In order for the second user to use the scan transfer function on the multifunctional peripheral 12, the second user inputs the QR code, which is delegation information, to the multifunctional peripheral 12. For example, when the QR code is held in front of a reading device built in the multifunctional peripheral 12, the reading device reads the QR code, and the delegation certificate receiving unit 36 receives the QR code. The state information reading unit 38 decodes the QR code to generate delegation information from the QR code, and reads a second hash value from the delegation information. In addition, the shared resources identifying unit 32 identifies an address book serving as shared resources that are used when using the scan transfer function represented by function information included in the delegation information.

The function use permitting unit 40 generates a hash value (namely, a first hash value) representing the state of the address book upon receipt of the QR code by the delegation certificate receiving unit 36, and compares the first hash value with the second hash value read from the above-mentioned QR code.

In the case where the first hash value and the second hash value match, the function use permitting unit 40 permits the second user to use the scan transfer function of transmitting scanned data by email using the address book. In this case, the second user is allowed to use any destination registered in the address book.

In the case where the first hash value and the second hash value do not match, the function use permitting unit 40 restricts the use of the scan transfer function of transmitting scanned data by email using the address book. For example, the second user is prohibited from using the scan transfer function using the address book. The function use permitting unit 40 may permit the second user to use the scan transfer function, but prohibit the use of the address book. In this case, destinations registered in the address book are not displayed on the UI 20, and the second user operates the UI 20 to enter a destination and uses the scan transfer function.

From when the QR code which is delegation information is given to the second user to when the second user exercises the usage right based on the delegation information (in short, when the second user uses the multifunctional peripheral 12 using the delegation information), the address book serving as shared resources may be changed. For example, the administrator of the address book may add a new address to the address book without knowing that a temporal usage right to use the scan transfer function has been given by the first user to the second user who does not have the usage right to use the function. In response to such a change in the address book, the address book may happen to be used by the second user in a state unexpected by the first user or the address book administrator who manages the address book. For example, when a new destination, which is unexpected by the first user at a time point at which the usage right to use the scan transfer function using the address book has been delegated to the second user, is added to the address book, the second user is allowed to refer to the new destination, which may result in leakage of information of the new destination to the second user. In addition, scanned data may be transmitted to the new destination in response to an operation performed by the second user. Unless the address book administrator informs the first user of addition of the new destination, the first user is unable to know that the new destination has been added to the address book, and thus is unable to get the opportunity to perform an operation for preventing the new destination from being used on the basis of the usage right given to the second user. If the first user knows that the new address has been added to the address book, the first user needs to perform an operation for preventing the new destination from being used on the basis of the usage right given to the second user, meaning that it is bothersome for the first user.

In this example, if the address book is changed from when the usage right to use the scan transfer function is given to the second user to when the second user exercises the usage right based on the delegation information, the first hash value and the second hash value do not match, thereby restricting the use of the scan transfer function by the second user. Therefore, the second user is prevented from using the scan transfer function or the address book in a state unexpected by the first user at a time point at which the usage right to use the scan transfer function has been given to the second user.

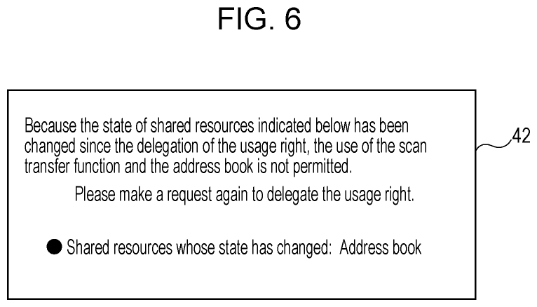

In the case where the first hash value and the second hash value do not match, the function use permitting unit 40 may notify the second user of the reason that the use of the shared resources is not permitted. For example, the function use permitting unit 40 may display information representing the reason on the display device of the UI 20, or may transmit the information to the second user's terminal apparatus 16B. FIG. 6 illustrates an example in which the reason that the use of the address book serving as shared resources is not permitted is displayed. As illustrated in FIG. 6, the function use permitting unit 40 displays a screen 42 for notifying the user of the reason on the display device of the UI 20. For example, a message such as “Because the address book is changed after the usage right to use the scan transfer function has been given to the second user, the use of the scan transfer function and the address book is not permitted.” is displayed on the screen 42.

In addition, whenever the address book is changed, the state information generating unit 34 may store data of the address book before the change in the storage device 22. In this case, on receipt of a QR code which is delegation information by the multifunctional peripheral 12, for every address book before the change, the state information generating unit 34 generates a hash value from data of the address book before the change. The function use permitting unit 40 compares a second hash value read from the QR code which is the delegation information and each hash value generated from data of each address book before the change, searches for data of the address book from which a hash value that matches the second hash value has been generated, and permits the second user to use the retrieved address book. For example, data of the address book at a time point at which the usage right to use the scan transfer function has been given to the second user is stored in the storage device 22, and a second hash value matches a first hash value generated from data of that address book. Therefore, the second user is permitted to use destinations at a time point at which the usage right to use the scan transfer function has been given to the second user. If the address book is changed after the usage right to use the scan transfer function has been given to the second user, a hash value generated from data of the address book after the change does not match the second hash value, and accordingly the second user is not permitted to use the address book after the change. Even in this case, the second user is permitted to use the address book at a time point at which the usage right to use the scan transfer function has been given to the second user. The address book at a time point at which the usage right to use the scan transfer function has been given to the second user corresponds to an example of a portion of the address book serving as shared resources that has not been changed since generation of the delegation information.

Although the address book is discussed as an example of shared resources in the above-described example, a paper tray provided in the multifunctional peripheral 12, a confidential box, or the like may be used as shared resources.

For example, the type of paper sheets contained in the paper tray corresponds to an example of the state of the paper tray. A first hash value is state information representing the type of paper sheets contained in the paper tray at a time point at which delegation information for giving a usage right to use the paper tray to the second user is input to the multifunctional peripheral 12. In short, the first hash value is state information representing the type of paper sheets contained in the paper tray when the second user exercises the usage right based on the delegation information. A second hash value is state information representing the type of paper sheets contained in the paper tray at a time point at which the multifunctional peripheral 12 receives from the first user a request for giving a usage right to use a function that uses the paper tray to the second user. In the case where the first hash value and the second hash value match, the function use permitting unit 40 permits the second user to use a function that uses the paper tray. In the case where the first hash value and the second hash value do not match, the function use permitting unit 40 restricts the use of a function that uses the paper tray. For example, the function use permitting unit 40 prohibits the use of the paper tray by the second user.

For example, it is conceivable that, although plain paper is contained in the paper tray when a usage right to use a function that uses the paper tray is given to the second user, the paper contained in the paper tray may be changed from plain paper to high-quality paper before the second user uses the function. In this case, the paper tray may be used by the second user in a state unexpected by the administrator who manages paper sheets or the first user. In the case where the first hash value and the second hash value do not match, the use of the paper tray by the second user is restricted. Thus, the paper tray is prevented from being used by the second user in a state unexpected by the administrator or the first user.

In addition, a confidential box is a storage area whose use is permitted by a user (hereinafter referred to as a “sharing destination”) who has a usage right to use the confidential box. For example, the sharing destination of a confidential box is the state of the confidential box. The sharing destination of a confidential box may be changed from when a usage right to use a function that uses the confidential box is given to the second user to when the second user exerts the usage right to use the confidential box. In this case, the first hash value and the second hash value do not match, and, as a result, the confidential box whose sharing destination has been changed is prevented from being used by the second user.

Hereinafter, modifications will be described.

For example, shared resources include a plurality of configurations. The state information generating unit 34 generates a hash value representing the state of at least one or some of the plurality of configurations. The state information generating unit 34 generates a hash value while changing a configuration for which a hash value is to be generated in accordance with the usage form of using the multifunctional peripheral 12 by the second user. For example, when the first user gives a usage right to use a function to the second user, the first user specifies the usage form of using the multifunctional peripheral 12 by the second user.

This will be described by using an address book by way of example. In the address book, for example, for each destination, the destination's name, phone number, and address are registered in association with one another. The destination's name, phone number, and address are configurations of the address book, which is an example of shared resources.

The state information generating unit 34 generates a hash value representing the state of at least one of each destination's name, phone number, and address in accordance with the usage form of using the multifunctional peripheral 12 by the second user.

The usage form of using the multifunctional peripheral 12 is, for example, the usage period of using the multifunctional peripheral 12 by the second user. The usage period is specified by the first user, and information representing the usage period is included in delegation information. The state information generating unit 34 reduces the number of configurations for which a hash value is to be generated as the usage period becomes longer, and generates a hash value (namely, a second hash value). The second hash value is included in delegation information.

When delegation information is input to the multifunctional peripheral 12 and is received by the delegation certificate receiving unit 36, the function use permitting unit 40 identifies the usage period of using the multifunctional peripheral 12 by the second user on the basis of information representing the usage period included in the delegation information. The function use permitting unit 40 generates a hash value (namely, a first hash value) that represents the state of the address book upon receipt of the delegation information by the delegation certificate receiving unit 36 and that represents the state of configurations the number of which is in accordance with the usage period. The function use permitting unit 40 compares the first hash value and a second hash value read from the delegation information, and permits or restricts the use of the scan transfer function in accordance with the comparison result.

For example, in the case where the usage period is less than a lower threshold, the state information generating unit 34 generates a second hash value representing the state of all configurations included in the address book (for example, each destination's name, phone number, and address). When delegation information is input to the multifunctional peripheral 12 and is received by the delegation certificate receiving unit 36, the function use permitting unit 40 generates a first hash value representing the state of all configurations of the address book upon receipt of the delegation information by the delegation certificate receiving unit 36, and permits or restricts the use of the scan transfer function in accordance with the result of comparison between the first hash value and the second hash value. If the state of one or some of the configurations of the address book is changed before the second user uses the multifunctional peripheral 12 using the delegation information, the first hash value and the second hash value do not match; accordingly, the use of the scan transfer function is restricted. For example, the first hash value and the second hash value do not match when even a destination's name is changed. Therefore, the use of the scan transfer function is restricted when only a destination's name is changed. The same applies to a phone number and an address.

For example, the second user whose usage period is set to less than the lower threshold is assumed as a user permitted to use the multifunctional peripheral 12 for a short period of time (for example, a user who uses the multifunctional peripheral 12 only once). By generating a hash value representing the state of all configurations of the address book, the scan transfer function and the address book are prevented from being used by the second user in a state unexpected by the administrator or the first user.

In the case where the usage period is greater than or equal to the lower threshold and less than an upper threshold, the state information generating unit 34 generates a second hash value representing the state of one or some of configurations included in the address book (for example, each destination's phone number and address). The upper threshold is a value representing a period longer than the lower threshold. When delegation information is input to the multifunctional peripheral 12 and is received by the delegation certificate receiving unit 36, the function use permitting unit 40 generates a first hash value representing the state of one or some of the configurations of the address book upon (for example, each destination's phone number and address) receipt of the delegation information by the delegation certificate receiving unit 36, and permits or restricts the use of the scan transfer function in accordance with the result of comparison between the first hash value and the second hash value. If at least one of a destination's phone number and address is changed before the second user uses the multifunctional peripheral 12 using the delegation information, the first hash value and the second hash value do not match; thus, the use of the scan transfer function is restricted. In contrast, the first hash value and the second hash value match when only a destination's name included in the address book is changed; thus, the use of the scan transfer function is permitted.

For example, the second user whose usage period is greater than or equal to the lower threshold and less than the upper threshold is assumed to be a user permitted to use the multifunctional peripheral 12 on a medium-term basis. By generating a hash value from one or some of the configurations of the address book and comparing the generated hash value with the second hash value, even if the state of a configuration for which no hash value has been generated is changed, the use of the scan transfer function is permitted.

In the case where the usage period is greater than or equal to the upper threshold, the state information generating unit 34 generates a second hash value representing the state of one or some of configurations included in the address book, which is/are fewer than the configurations in the case where the usage period is less than the upper threshold. For example, the state information generating unit 34 generates a second hash value representing the state of each destination's address. When delegation information is input to the multifunctional peripheral 12 and is received by the delegation certificate receiving unit 36, the function use permitting unit 40 generates a first hash value representing the state of each destination's address included in the address book upon receipt of the delegation information by the delegation certificate receiving unit 36, and permits or restricts the use of the scan transfer function in accordance with the result of comparison between the first hash value and the second hash value. If a destination's address is changed before the second user uses the multifunctional peripheral 12 using the delegation information, the first hash value and the second hash value do not match; thus, the use of the scan transfer function is restricted. In contrast, the first hash value and the second hash value match when only a destination's name and phone number included in the address book are changed; thus, the use of the scan transfer function is permitted.

For example, the second user whose usage period is set to greater than or equal to the upper threshold is assumed to be a user permitted to use the multifunctional peripheral 12 on a long-term basis. For example, a user who is entrusted with a service or an operation corresponds to an example of the second user.

A configuration for which no hash value is to be generated may be a configuration that is less important than a configuration for which a hash value is to be generated. For example, each destination's name is a configuration that is less important than each destination's phone number and address; thus, a hash value representing the state of each destination's name need not be generated. In this case, the second user is permitted to use the scan transfer function even if a destination's name, which is less important, is changed, deleted, or added. In contrast, the second user is restricted to use the scan transfer function if a phone number or an address, which is more important, is changed, deleted, or added. Accordingly, a phone number or an address is prevented from being used by the second user in a state unexpected by the administrator or the first user.

The number of configurations for which a hash value is to be generated may be reduced as the reliability of the second user becomes higher. The reliability of the second user is specified by the first user, and information representing the reliability is included in delegation information. The state information generating unit 34 reduces the number of configurations for which a hash value is to be generated as the reliability becomes higher, and generates a hash value (namely, a second hash value). The second hash value is included in delegation information.

When delegation information is input to the multifunctional peripheral 12 and is received by the delegation certificate receiving unit 36, the function use permitting unit 40 identifies the reliability of the second user on the basis of information representing the reliability included in the delegation information. The function use permitting unit 40 generates a hash value (namely, a first hash value) that represents the state of the address book upon receipt of the delegation information by the delegation certificate receiving unit 36 and that represents the state of configurations the number of which is in accordance with the reliability. The function use permitting unit 40 compares the first hash value and a second hash value read from the delegation information, and permits or restricts the use of the scan transfer function in accordance with the comparison result.

For example, in the case where the reliability is less than a lower threshold, the state information generating unit 34 generates a second hash value representing the state of all configurations included in the address book (for example, each destination's name, phone number, and address). In this case, a first hash value representing the state of all configurations of the address book upon receipt of delegation information by the delegation certificate receiving unit 36 is generated, and the use of the scan transfer function is permitted or restricted in accordance with the result of comparison between the first hash value and the second hash value. For example, the second user whose reliability is set to less than the lower threshold is assumed to be a user permitted to use the multifunctional peripheral 12 on a short-term basis.

In the case where the reliability is greater than or equal to the lower threshold and less than an upper threshold, the state information generating unit 34 generates a second hash value representing the state of one or some of configurations included in the address book (for example, each destination's phone number and address). The upper threshold is a value representing reliability higher than the lower threshold. In this case, a first hash value representing the state of one or some of the configurations (for example, each destination's phone number and address) of the address book upon receipt of delegation information by the delegation certificate receiving unit 36 is generated, and the use of the scan transfer function is permitted or restricted in accordance with the result of comparison between the first hash value and the second hash value. For example, the second user whose reliability is set to greater than or equal to the lower threshold and less than the upper threshold is assumed to be a user permitted to use the multifunctional peripheral 12 on a medium-term basis.

In the case where the reliability is greater than or equal to the upper threshold, the state information generating unit 34 generates a second hash value representing the state of one or some of configurations included in the address book, which is/are fewer than the configurations in the case where the reliability is less than the upper threshold. For example, the state information generating unit 34 generates a second hash value representing the state of each destination's address. In this case, a first hash value representing the state of each destination's address included in the address book upon receipt of delegation information by the delegation certificate receiving unit 36 is generated, and the use of the scan transfer function is permitted or restricted in accordance with the result of comparison between the first hash value and the second hash value. For example, the second user whose reliability is set to greater than or equal to the upper threshold is assumed to be a user permitted to use the multifunctional peripheral 12 on a long-term basis.

Note that a configuration for which a hash value is to be generated may be specified by the first user in the above-described exemplary embodiment. This will be described by using an address book by way of example. The address book as a whole, or only each destination's name, phone number, or address, or a plurality of configurations may be specified by the first user as one or more configurations for which a hash value is to be generated.

The degree of restriction of the use of a function of the multifunctional peripheral 12 may be changed in accordance with the settings or other environmental factors of the multifunctional peripheral 12.

For example, in the case where the use of the multifunctional peripheral 12 is permitted for a short period of time, as in the case of a temporary use or a trial period, the degree of restriction may be made moderate in the case where, for example, a network (such as a LAN) where the multifunctional peripheral 12 is usable is isolated and disconnected from an external network and data is not transferrable to the outside (such as the outside of the LAN) or in the case where the paper tray of the multifunctional peripheral 12 is locked. For example, even if information such as the address book or the network settings is changed, a hash value is generated such that the use of the scan function or the use of functions of the multifunctional peripheral 12 as a whole will not be restricted. The case in which a person unrelated to a company that is in charge of managing the multifunctional peripheral 12 is permitted to temporarily use the multifunctional peripheral 12 corresponds to an example of the use for a short period of time.

In contrast, in the case where the use of the multifunctional peripheral 12 is permitted for a short period of time, the degree of restriction may be made stricter in the case where, for example, a network where the multifunctional peripheral 12 is usable is connected to an external network and data is transferrable to the outside. For example, if information such as the address book or the network settings is changed, a hash value is generated such that the use of the scan function or the use of functions of the multifunctional peripheral 12 as a whole will be restricted.

In the case where the use of the multifunctional peripheral 12 is permitted for a long period of time, the degree of restriction may be made more moderate in the case where the second user is a reliable user, such as when the second user is staff of a shared workspace where the multifunctional peripheral 12 is located or the second user is a user who belongs to the same company as the first user. For example, even if information such as the address book or the network settings is changed, a hash value is generated such that the use of the scan function or the use of functions of the multifunctional peripheral 12 as a whole will not be restricted.

In contrast, in the case where the use of the multifunctional peripheral 12 is permitted for a long period of time, the degree of restriction may be made a little more strict in the case where, for example, a network where the multifunctional peripheral 12 is usable is connected to an external network and data is transferrable to the outside. For example, even if the address book is changed, a hash value is generated such that the use of the scan function or the use of functions of the multifunctional peripheral 12 as a whole will not be restricted. In contrast, if the network settings are changed, a hash value is generated such that the use of the scan function or the use of functions of the multifunctional peripheral 12 as a whole will be restricted. A change in the network settings may be a change in settings such as the IP address of the multifunctional peripheral 12. In the case where a plurality of network boards is provided in the multifunctional peripheral 12, a change in the network settings may be replacement of LAN cables connected to the network boards. For example, a resident employee entrusted with a service or an operation is assumed as the second user on which such restrictions are imposed. For example, it is conceivable that, to develop part of software of a new product, an engineer who is an entrusted employee is permitted to use the multifunctional peripheral 12 for a relatively long period of time (such as six months). In such a case, if the second user is permitted to send data using the address book, in order to prevent wrong transmission and the like, it is conceivable to restrict the use of functions of the multifunctional peripheral 12 if the network settings are changed. If the address book is changed, the second user may not be permitted to use the address book after the change without any exception. If the first user who has given a usage right to use the multifunctional peripheral 12 to the second user changes the address book, the second user may be permitted to use the address book after the change; otherwise, the second user may not be permitted to use the address book after the change.

In the case where a hash value representing the state of the address book as a whole is generated, if a destination included in the address book is deleted, the first hash value and the second hash value do not match. Even in this case, the function use permitting unit 40 may permit the second user to use the scan transfer function. If a destination is deleted, it is difficult to conceive that information other than the address book before deletion of the destination is used by the second user. Thus, the function use permitting unit 40 may permit the second user to use the function. For example, data of the address book before the deletion is stored in the storage device 22, and the function use permitting unit 40 generates a hash value from the data of the address book, which is stored in the storage device 22, and permits or restricts the use of the scan transfer function in accordance with the hash value comparison result.

In addition, a hash value may be generated for, among items of information included in the address book, information regarding transmission to the outside; and no hash value may be generated for information regarding transmission to the inside. The term “inside” refers to, for example, apparatuses and users who belong to the same intranet as the multifunctional peripheral 12. The term “outside” refers to, for example, apparatuses and users who do not belong to that intranet. For example, information regarding transmission to the outside includes the address (such as the IP address) of an apparatus that does not belong to the same intranet as the multifunctional peripheral 12, and the email address of a user who does not belong to the same intranet as the multifunctional peripheral 12. Information regarding transmission to the inside includes information regarding Server Message Block (SMB) communication used in the same intranet as the multifunctional peripheral 12.

In the embodiment above, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device). In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive a request made by a first user who has a usage right to use a function of an apparatus to be used;
output delegation information representing that the usage right to use the function is to be delegated to a second user who does not have the usage right to use the function, the delegation information including state information that represents a state of shared resources that are used when the function is used and that represents a state upon receipt of the request;
receive the delegation information; and
permit or restrict use of the function in accordance with a result of comparison between the state of the shared resources upon receipt of the delegation information and the state represented by the state information included in the received delegation information.

2. The information processing apparatus according to claim 1, wherein the state of the shared resources is changeable by another user other than the first user.

3. The information processing apparatus according to claim 1, wherein the state information is a hash value representing the state of the shared resources.

4. The information processing apparatus according to claim 2, wherein the state information is a hash value representing the state of the shared resources.

5. The information processing apparatus according to claim 3, wherein:
the shared resources include a plurality of configurations,
the hash value is a value representing a state of at least one or some of the plurality of configurations, and
the processor is further configured to generate a hash value while changing a configuration for which a hash value is to be generated in accordance with a usage form of using the apparatus by the second user.

6. The information processing apparatus according to claim 4, wherein:
the shared resources include a plurality of configurations,
the hash value is a value representing a state of at least one or some of the plurality of configurations, and
the processor is further configured to generate a hash value while changing a configuration for which a hash value is to be generated in accordance with a usage form of using the apparatus by the second user.

7. The information processing apparatus according to claim 5, wherein:
the usage form is a usage period of using the apparatus, and
the processor is configured to reduce a number of configurations for which a hash value is to be generated as the usage period becomes longer.

8. The information processing apparatus according to claim 6, wherein:
the usage form is a usage period of using the apparatus, and
the processor is configured to reduce a number of configurations for which a hash value is to be generated as the usage period becomes longer.

9. The information processing apparatus according to claim 3, wherein:
the shared resources include a plurality of configurations,
the hash value is a value representing a state of at least one or some of the plurality of configurations, and
the processor is further configured to reduce a number of configurations for which a hash value is to be generated as reliability of the second user becomes higher.

10. The information processing apparatus according to claim 4, wherein:
the shared resources include a plurality of configurations,
the hash value is a value representing a state of at least one or some of the plurality of configurations, and
the processor is further configured to reduce a number of configurations for which a hash value is to be generated as reliability of the second user becomes higher.

11. The information processing apparatus according to claim 1, wherein:
the processor is configured to:
permit the use of the function in a case where the state of the shared resources upon receipt of the delegation information and the state represented by the state information included in the received delegation information match, and
permit use of only a portion of the shared resources that has a state upon receipt of the request in a case where the state of the shared resources upon receipt of the delegation information and the state represented by the state information included in the received delegation information do not match.

12. The information processing apparatus according to claim 2, wherein:
the processor is configured to:
permit the use of the function in a case where the state of the shared resources upon receipt of the delegation information and the state represented by the state information included in the received delegation information match, and
permit use of only a portion of the shared resources that has a state upon receipt of the request in a case where the state of the shared resources upon receipt of the delegation information and the state represented by the state information included in the received delegation information do not match.

13. The information processing apparatus according to claim 3, wherein:
the processor is configured to:
permit the use of the function in a case where the state of the shared resources upon receipt of the delegation information and the state represented by the state information included in the received delegation information match, and
permit use of only a portion of the shared resources that has a state upon receipt of the request in a case where the state of the shared resources upon receipt of the delegation information and the state represented by the state information included in the received delegation information do not match.

14. The information processing apparatus according to claim 4, wherein:
the processor is configured to:
permit the use of the function in a case where the state of the shared resources upon receipt of the delegation information and the state represented by the state information included in the received delegation information match, and
permit use of only a portion of the shared resources that has a state upon receipt of the request in a case where the state of the shared resources upon receipt of the delegation information and the state represented by the state information included in the received delegation information do not match.

15. The information processing apparatus according to claim 5, wherein:
the processor is configured to:
permit the use of the function in a case where the state of the shared resources upon receipt of the delegation information and the state represented by the state information included in the received delegation information match, and
permit use of only a portion of the shared resources that has a state upon receipt of the request in a case where the state of the shared resources upon receipt of the delegation information and the state represented by the state information included in the received delegation information do not match.

16. The information processing apparatus according to claim 6, wherein:
the processor is configured to:
permit the use of the function in a case where the state of the shared resources upon receipt of the delegation information and the state represented by the state information included in the received delegation information match, and
permit use of only a portion of the shared resources that has a state upon receipt of the request in a case where the state of the shared resources upon receipt of the delegation information and the state represented by the state information included in the received delegation information do not match.

17. The information processing apparatus according to claim 7, wherein:
the processor is configured to:
permit the use of the function in a case where the state of the shared resources upon receipt of the delegation information and the state represented by the state information included in the received delegation information match, and
permit use of only a portion of the shared resources that has a state upon receipt of the request in a case where the state of the shared resources upon receipt of the delegation information and the state represented by the state information included in the received delegation information do not match.

18. The information processing apparatus according to claim 1, wherein:
the processor is configured to:
permit the use of the function in a case where the state of the shared resources upon receipt of the delegation information and the state represented by the state information included in the received delegation information match, and
not permit use of the shared resources as a whole in a case where the state of the shared resources upon receipt of the delegation information and the state represented by the state information included in the received delegation information do not match.

19. The information processing apparatus according to claim 18, wherein the processor is further configured to notify the second user of a reason that the use of the shared resources is not permitted.

20. A non-transitory computer readable medium storing a program causing a computer to execute a process, the process comprising:
receiving a request made by a first user who has a usage right to use a function of an apparatus to be used;
outputting delegation information representing that the usage right to use the function is to be delegated to a second user who does not have the usage right to use the function, the delegation information including state information that represents a state of shared resources that are used when the function is used and that represents a state upon receipt of the request;
receiving the delegation information; and
permitting or restricting use of the function in accordance with a result of comparison between the state of the shared resources upon receipt of the delegation information and the state represented by the state information included in the received delegation information.
